(19) United States
(12) Patent Application Publication
(10) Pub. No.: US 2009/0276700 A1
(43) Pub. Date: Nov. 5, 2009

(54) Method, apparatus, and computer program product for determining user status indicators

(75) Inventors: Marko Anderson, Helsinki (FI); Marco Paglia, London (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia corporation

(21) Appl. No.: 12/111,999

(22) Filed: Apr. 30, 2008

(51) Int. Cl. G06F 3/048

(52) U.S. Cl. 715/700

(57) ABSTRACT

An apparatus for providing user status indicators may include a processor. The processor may be configured to receive context information from one or more platforms. The processor may also be configured to determine one or more user status indicators based on the context information and provide for presentation of the user status indicators in association with the user account. Associated methods and computer program products may also be provided.

### TECHNICAL FIELD

Embodiments of the present invention relate generally to information collection and analysis and, more particularly, relate to an apparatus, method and a computer program product for determining user status indicators.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices and other computing devices. However, as the ease of information transfer increases, users continue to demand more and different types of information. Mobile devices, networks, personal computers, and other computing devices can now capture numerous types of information about users and their activities. Such information may include location information, phone call information (e.g., what contacts were called, duration of calls, what calls were received), status information (e.g., working, sleeping, watching a movie), media information (e.g., recent photographs taken, music played), etc. The availability of this information is desirable to users, not only with respect to information about themselves and their own activities, but also with respect to their friends and business contacts.

Currently, these and other types of information are being captured by various computing devices, but the information often goes unused since no common outlet for the information is available to users. Further, due to the lack of a common outlet for the information, the information cannot be shared with other users on a network. As such, users cannot consider, utilize, or interact with the information to, for example, make decisions regarding activities performed by the users.

As such, it would be desirable to provide mechanisms for aggregating user information that is captured by various computing devices associated with the user. Moreover, it would be desirable to provide the information in a usable form for consideration and interaction by a user. In this same regard, it would be desirable to provide the ability to share a user's captured information with other users and allow the other users to view and interact with the information.

### BRIEF SUMMARY

A method, apparatus, and computer program product are therefore provided for determining user status indicators. In this regard, exemplary embodiments of the present invention may receive context information from one or more platforms, one of which may be a mobile terminal. In this regard, the mobile terminal may be associated with a user account of an online service. Further, the context information may be comprised of mobile terminal context information and service context information. Exemplary embodiments of the present invention may also determine one or more user status indicators based on the context information and provide for presentation of the user status indicators in association with the user account. Some embodiments may also determine user activities based on changes in one or more status indicators and provide for presentation of the user activities in association with the user account.

In one exemplary embodiment, a method for determining user status indicators is provided. The method may include receiving context information from one or more platforms. The method may also include determining one or more user status indicators based on the context information, and providing for presentation of the user status indicators in association with the user account.

In another exemplary embodiment, a computer program product for determining user status indicators is provided. The computer program product may include at least one computer-readable storage medium having computer-readable program code portions stored therein. The computer-readable program code portions may include a first program code portion, a second program code portion, and a third program code portion. The first program code portion may be configured to receive context information from one or more platforms. The second program code portion may be configured to determine one or more user status indicators based on the context information, and the third program code portion may be configured to provide for presentation of the user status indicators in association with the user account.

In another exemplary embodiment, an apparatus for determining user status indicators is provided. The apparatus may include a processor. The processor may be configured to receive context information from one or more platforms. The processor may also be configured to determine one or more user status indicators based on the context information and provide for presentation of the user status indicators in association with the user account.

In one exemplary embodiment, an apparatus for determining user status indicators is provided. The apparatus may include means for receiving context information from a mobile terminal. The apparatus may also include means for determining one or more user status indicators based on the context information and means for providing for presentation of the user status indicators in association with the user account.

In some exemplary embodiments, a method, apparatus, and computer program production are provided for determining and presenting user activities. In these exemplary embodiments, the user activities may be based on changes in the one or more user status indicators. Further, the embodiments may provide for presentation of the user activities in association with the user account. In some embodiments, the use activities may be determined based on current and past user status indicators.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 illustrates a block diagram showing an apparatus for determining user status indicators with associated network connectivity according to an exemplary embodiment of the present invention;

FIG. 3a illustrates an exemplary presentation of user status indicators according to exemplary embodiments of the present invention;

FIG. 3b illustrates an exemplary presentation of user activities according to exemplary embodiments of the present invention;

FIG. 4 is a flowchart according to an exemplary method for determining user status indicators according to an exemplary embodiment of the present invention;

FIG. 5 is a flowchart according to an exemplary method for determining user status indicators according to an exemplary embodiment of the present invention; and

FIG. 6 illustrates an exemplary system of network entities according to exemplary embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

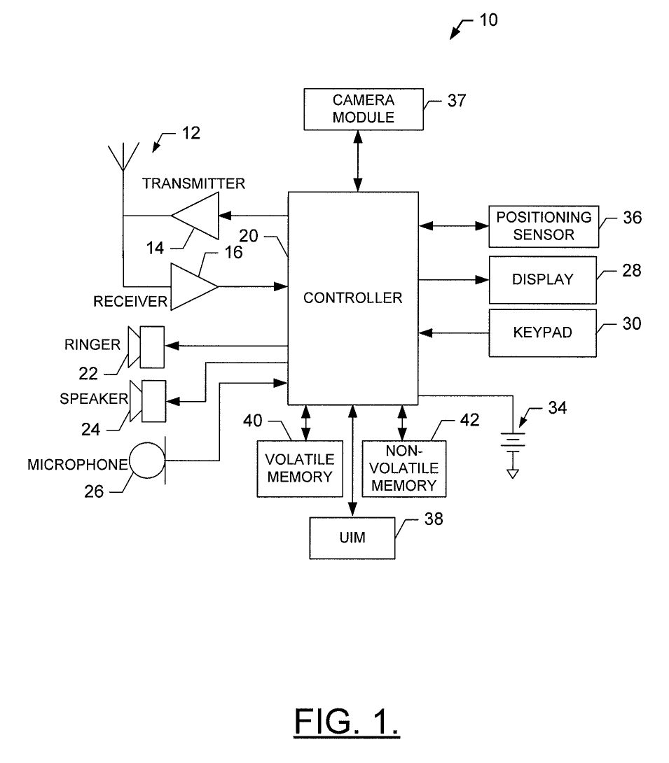

FIG. 1, one aspect of the invention, illustrates a block diagram of a mobile terminal 10 that would benefit from, and may be an exemplary apparatus of, embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the apparatus and method of embodiments of the present invention will be primarily described in conjunction with mobile communications applications. It should be understood, however, that the apparatus and method of embodiments of the present invention can be utilized in conjunction with a variety of other applications, both in the mobile communications industries and outside of the mobile communications industries.

The mobile terminal 10 may include an antenna 12 (or multiple antennas) in operable communication with a transmitter 14 and a receiver 16. The mobile terminal 10 may further include an apparatus, such as a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9 generation (3.9G) wireless communication protocols, such as Evolved Universal Terrestrial Radio Access Network (E-UTRAN), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN), or other communication networks. Further, the mobile terminal 10 can communicate in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

The mobile terminal 10 may further include a positioning sensor 36 such as, for example, a global positioning system (GPS) module in communication with the controller 20. The positioning sensor 36 may be any means, device or circuitry for locating the position of mobile terminal 10. The positioning sensor 36 may include all hardware for locating the position of a mobile terminal 10. Alternatively or additionally, the positioning sensor 36 may utilize a memory device of the mobile terminal 10 to store instructions for execution by the controller 20 in the form of software necessary to determine the position of the mobile terminal 10. Although the positioning sensor 36 of this example may be a GPS module, the positioning sensor 36 may include or otherwise alternatively be embodied as, for example, an assisted global positioning system (Assisted-GPS) sensor, or a positioning client, which may be in communication with a network device to receive and/or transmit information, such as a sky or floor sensor, for use in determining a position of the mobile terminal 10. In this regard, the position of the mobile terminal 10 may be determined by GPS, as described above, cell ID, signal triangulation, or other mechanisms as well. In one exemplary embodiment, the positioning sensor 36 includes a pedometer or inertial sensor. As such, the positioning sensor 36 may be capable of determining a location of the mobile terminal 10, with respect to, for example, longitudinal and latitudinal directions, and altitude direction of the mobile terminal 10, or a position relative to a reference point such as a destination or start point. Information from the positioning sensor 36 may then be communicated to a memory of the mobile terminal 10 or to another memory device to be stored as a position history or location information. Additionally, the positioning sensor 36 may be capable of utilizing the controller 20 to transmit/receive, via the transmitter 14/receiver 16, location information such as the position of the mobile terminal 10.

In some embodiments, the mobile terminal 10 includes a media capturing element, such as a camera, video and/or audio module, in communication with the controller 20. The media capturing element may be any means for capturing images, video and/or audio for storage, display or transmission. For example, in an exemplary embodiment in which the media capturing element is a camera module 37, the camera module 37 may include a selective capture mode where camera module 37 can form and save a digital image file from an image captured by camera module 37. In some embodiments, the camera module 37 can implement a preview mode where the current view from the camera module's optical hardware is displayed on, for example, display 28. In some embodiments, image data captured during preview mode is not saved for longevity, but rather continuously overwritten in order to depict the current view from the optical hardware. Additionally, while in preview mode a delay can exist due to, for example, hardware and software constraints. As such, a display of the current view of camera module 37 can be a display of the view from camera module 37 at a time in the past that can be described by the current time minus the delay.

As such, the camera module 37 can include all hardware, such as a lens or other optical component(s), and software necessary for creating a digital image file from a captured image, in the selective capture mode, or for displaying the current view of the camera module, in a preview mode. Camera module 37 may also include all hardware, such as a lens or other optical component(s), and software necessary to provide image zooming functionality. Image zooming functionality can include the ability to magnify or de-magnify an image prior to or subsequent to capturing an image. Image zooming functionality can be used in selective capture mode and preview mode.

In either selective capture mode or preview mode, camera module 37 can operate in conjunction with positioning sensor 37 and orientation module 39 to associate the location and orientation information of mobile terminal 10, at the moment of image capture. In some embodiments, a subset of the location and orientation information of mobile terminal 10, at the moment of image capture, can be utilized. Similarly, a zoom level, indicating the degree that camera module 36 is zoomed at the moment of image capture, can be associated with a digital image file. For example, in preview mode, in some embodiments, a set of location information, orientation information and zoom level can be associated with each captured image frame, or at some lesser interval in which a common set of information is associated with each image frame captured within the interval. In some embodiments, the zoom level can include information regarding the aspect ratio of a captured image.

Alternatively, the camera module 37 may include only the hardware needed to view an image, while a memory device of the mobile terminal 10 stores instructions for execution by the controller 20 in the form of software necessary to create a digital image file from a captured image. In an exemplary embodiment, the camera module 37 may further include a processor or co-processor which assists the controller 20 in processing image data and an encoder and/or decoder for compressing and/or decompressing image data. The encoder and/or decoder may encode and/or decode according to, for example, a joint photographic experts group (JPEG) standard or other format.

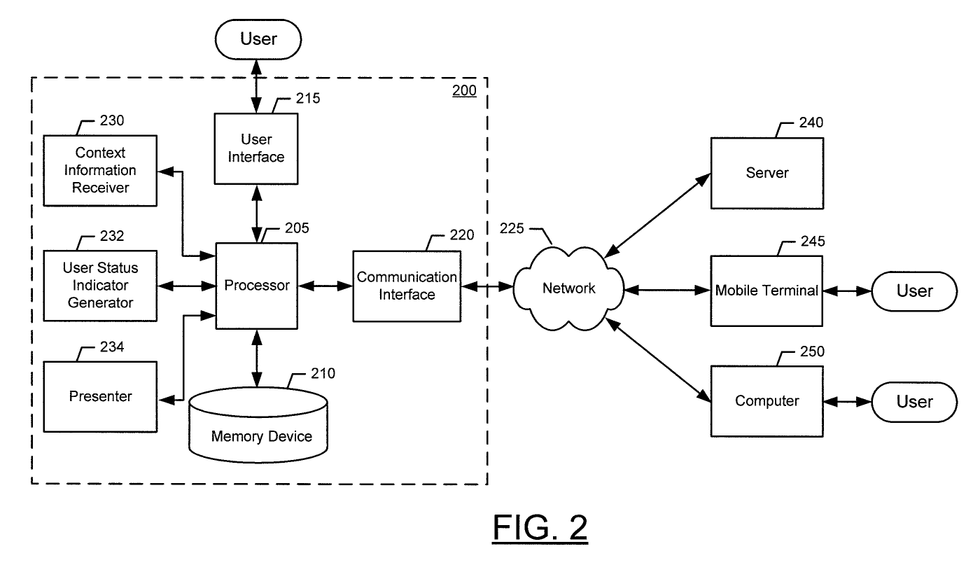

Referring now to FIG. 2, an exemplary apparatus 200 for determining status indicators is provided. Apparatus 200 may be embodied as a server or other network device including, for example, a mobile terminal, such as mobile terminal 10 of FIG. 1. The apparatus 200 may include or otherwise be in communication with a processor 205, a user interface 215, a communication interface 220, and a memory device 210. The memory device 210 may include, for example, volatile and/or non-volatile memory (e.g., volatile memory 40 and/or non-volatile memory 42). The memory device 210 may be configured to store information, data, applications, instructions, or the like for enabling the apparatus to carry out various functions in accordance with exemplary embodiments of the present invention. For example, the memory device 210 could be configured to buffer input data for processing by the processor 205. Additionally or alternatively, the memory device 210 could be configured to store instructions for execution by the processor 205. As yet another alternative, the memory device 210 may be one of a plurality of databases that store information in the form of static and/or dynamic information, for example, in association with mobile terminal context information, service context information, user status indicators, user activities, or the like.

The processor 205 may be embodied in a number of different ways. For example, the processor 205 may be embodied as a microprocessor, a coprocessor, a controller (e.g, controller 20 from FIG. 1), or various other processing means or elements including integrated circuits such as, for example, an ASIC (application specific integrated circuit) or FPGA (field programmable gate array). In an exemplary embodiment, the processor 205 may be configured to execute instructions stored in the memory device 210 or otherwise accessible to the processor 205.

The user interface 215 may be in communication with the processor 205 to receive an indication of a user input at the user interface 215 and/or to provide an audible, visual, mechanical, or other output to the user. As such, the user interface 215 may include, for example, a keyboard, a mouse, a joystick, a touch screen display, a conventional display, a microphone, a speaker, or other input/output mechanisms. In an exemplary embodiment in which the apparatus 200 is embodied as a server, the user interface 215 may be limited, or even eliminated.

The communication interface 220 may be embodied as any device or means embodied in either hardware, software, or a combination of hardware and software that is configured to receive and/or transmit data from/to a network and/or any other device or module in communication with the apparatus 200. In this regard, the communication interface 220 may include, for example, an antenna, a transmitter, a receiver, a transceiver and/or supporting hardware or software for enabling communications with network 225, which may be any type of wired or wireless network. Via the communication interface 220 and the network 225, the apparatus 200 may communicate with the server 240, the mobile terminal 245, and/or the computer 250.

The server 240 may be any type of computing device for storing, retrieving, computing, transmitting, and receiving data. The server 240 may include a memory device, a processor, and a communication interface for communicating with the network 225. In some embodiments, the server 240 may be a web server, database server, file server, or the like.

The mobile terminal 245 may also be any type of device for storing, retrieving, computing, transmitting and receiving data. In some embodiments, mobile terminal 245 may be embodied as a mobile terminal 10 of FIG. 1.

The computer 250 may also be any type of computing device for storing, retrieving, computing, transmitting, and receiving data. The computer 250 may include a memory device, a processor, user interface for presenting output to a user and receiving input from a user, and a communication interface for communicating with the network 225. In some embodiments, the computer 250 may be a personal computer capable of running applications including web-browsers, widgets, or other applications, which may or may not involve the transmission/reception of data to/from the network 225. Via the computer 250, a user may access an exemplary online service using a browser or a dedicated application. The context information receiver 230, the status generator 232, and the presenter 234 of apparatus 200 may be any means or device embodied in hardware, software, or a combination of hardware and software that is configured to carry out the functions of the context information receiver 230, the status generator 232, and the presenter 234, respectively, as described herein. In an exemplary embodiment, the processor 205 may include, or otherwise control the content information receiver 230, the status generator 232, and/or the presenter 234. In various exemplary embodiments, the context information receiver 230, the status generator 232, and the presenter 234 may reside on a server, or other network device including a mobile terminal, such as mobile terminal 10 of FIG. 1.

In some embodiments, the system of FIG. 2 may be utilized for synchronization of data amongst the various network platforms. In this regard, the network platforms (i.e., the apparatus 200, the server 240, the mobile terminal 245, the computer 250, etc.) may be used by a user to access data. In some embodiments, the network platforms may be used to access data associated with an online service account. Any type of data may be synchronized amongst the platforms and made available for access. Types of data may include status information, content, user profile information, shared files (e.g., documents, photos, media content, etc.), mobile terminal context information, service context information, user status indicators, user activities, or the like. For example, a contacts list may be accessed and/or synchronized (i.e., updated) via the mobile terminal 245, the computer 250, the server 240, or the apparatus 200. Upon modifying the contacts list, the new information may be transmitted to a data storage device (e.g., the apparatus 200 or the server 240) or otherwise made available to the various network platforms for subsequent access.

In this manner, data modified on one platform may be available to another platform. For example, the modified contact information may be automatically transmitted from the mobile terminal 245 to the server 240 or the apparatus 200 for synchronization purposes. As such, the user may later access the modified contact information via computer 250 and/or a browser.

In some embodiments, a user may set synchronization parameters, which may identify types of data that should be synchronized and types of data that need not be synchronized. For example, a user may set the synchronization parameters to synchronize the contact list, but may also set the synchronization parameters such that user profile information need not be synchronized. In various embodiments, various mobile terminal context information, service context information, user status indicators, and/or user activities may or may not be synchronized.

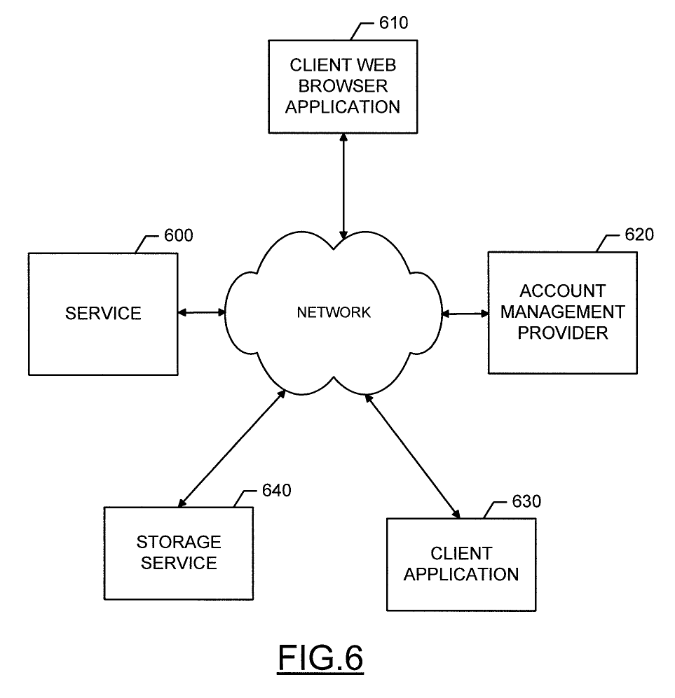

In this regard, and referring now to FIG. 6, an embodiment of a system in accordance with aspects of the present invention is illustrated. The system of FIG. 6 includes a service 600, a client web browser application 610, an account management provider 620, a client application 630, and a storage service 640. The service 600, the client web browser application 610, the account management provider 620, the client application 630, and the storage service 640 may be interconnected via the illustrated network, which may operate in the same manner as network 225.

The service 610, the account management provider 620, and the storage service 640 may collectively represent an embodiment of the apparatus 200 of FIG. 2. In this regard, the service 610 may represent an internet or network service (e.g., a website, a social networking website, a blog website, a web feed, a widget, or the like) that may receive and interact with context information, user status indicators, or the like in a manner described with respect to the context information receiver 230, the user status indicator generator 232, the presenter 234, and the processor 205. Various types of data, such as, but not limited to, context information, user status indicators, may be synchronized with and/or otherwise transferred to and from the service 600. The service 600 may utilize the storage service 640 for storage and retrieval of data by the service 600. In various embodiments, the storage service 640 may operate in the same manner as the memory device 210 and/or the server 240. Further, the account management provider 620 may operate together with the various other network entities to perform account management and security features. In some embodiments, login information and passwords are first directed to the account management provider 620 for verification. Upon verification, the account management provider 620 may provide access to, and allow communications between, various network entities using, for example, a token or other access key.

Client application 630 may be a software or hardware application residing and operating on a platform, such as a computer, mobile terminal, or the like, that may be used to interact with the service 600. In some embodiments, the client application 630 may reside and operate on the apparatus 200, the mobile terminal 245, the computer 250, or the like, and may operate in the same manner as apparatus 200, the mobile terminal 245, the computer 250, or the like. The client application may be downloaded to and/or installed on the platform. In some embodiments, the client application 630 may be specifically tailored to interact with the service 600. Via the client application 630, the platform, and the user of the platform, may interact with the service 600 to send and receive data, such as context information, user status indicators or the like, between the client application 630 and the service 600. The client application 630 may facilitate the gathering and storage of such as context information, user status indicators or the like for subsequent transmission to the service 600.

Similar to the client application 630, the client web browser application 610 may be a software or hardware application residing and operating on a platform, such as a computer, mobile terminal, or the like, that may be used to interact with the service 600. In this regard, the client web browser application 610 may be a generic network communication application for interacting with various network entities, including the service 600. In some embodiments, the client web browser application 610 may reside and operate on the apparatus 200, the mobile terminal 245, the computer 250, or the like, and may operate in the same manner as the apparatus 200, the mobile terminal 245, the computer 250, or the like. Via the client web browser application 710, the platform, and the user of the platform, may interact with the service 600 to send and receive, as well as synchronize, data, such as such as context information, user status indicators or the like, between the client web browser application 610 and the service 600. The client web browser application 610 may facilitate the gathering and storage of such as context information, user status indicators or the like for subsequent transmission to the service 600.

Referring back to FIG. 2, the context information receiver 230 may be configured to receive context information, where the context information may include mobile terminal context information and service context information. Means for receiving context information may include the processor 205, the context information receiver 230, a receiver, algorithms for receiving context information described herein and/or the like. In some embodiments, the mobile terminal context information may be received from a mobile terminal, such as the mobile terminal 245. In this regard, a mobile terminal may capture mobile terminal context information associated with the current operations of the mobile terminal. The mobile terminal may also transmit the mobile event items to the apparatus 200 and the context information receiver 230. The mobile terminal associated with the mobile terminal context information may also be associated with a user account of an online service.

The context of a mobile terminal may be a description of the operations currently being performed by the mobile terminal, or current data collected in association with operations performed by the mobile terminal. Context information may be passively collected by a mobile terminal when a user is not directly interacting with the mobile terminal. Examples of passively collected context information may include location information, network connectivity, battery level, or the like. Context information may also be actively collected by a mobile terminal when a user is directly interacting with the mobile terminal. Examples of actively collected context information may include the applications a user is currently utilizing on the mobile terminal, information about calls initiated or received by a user, or the like.

As such, the context of a mobile terminal may include, for example, whether the mobile terminal is currently handling a communication channel (e.g., phone call, email, text message, instant message, etc.). The context of a mobile terminal may be based on the applications currently being performed by the mobile terminal. For example, the context of a mobile terminal may be based on whether a user is playing a game, interacting with a media item (e.g., a photo, music track, video, etc.), capturing a media item on the mobile terminal, downloading or uploading content, or the like. Further, the context of a mobile terminal may be based on the location of the mobile terminal. In some embodiments, information regarding the location of the mobile terminal may be captured by a positioning sensor, such as the positioning sensor 36 of mobile terminal 10. In some instances, the context of a mobile terminal may be based on a current profile setting of the mobile terminal. Profile settings may include, for example, loud, silent, vibrate, meeting, and the like. The context of a mobile terminal may also be based on various additional operations performed on or by the mobile terminal (e.g., modifying a contact list, web-browsing, detecting network connections, etc.).

In some embodiments, the context information receiver 230 may be configured to receive service context information, such as internet service context information. In some embodiments, service context information may be received from various platforms including a server (e.g., the server 240), a mobile terminal (e.g., the mobile terminal 245), or a computer (e.g., the computer 250). Service context information may include indications of activities performed by a user while logged into an online service (e.g., a social networking website, instant messaging site, or the like) and within the constraints of the online service. In contrast, in some embodiments, mobile terminal context information may be captured with respect to activities and operations that occur outside of an online service. In this regard, an online service may be a social networking website, or any type of website that provides for sharing of information between users. A user may log into the online service and interact with features of the online service. In this regard, example service context information may include information regarding the type of platform a user is utilizing to access the online service, how long a user has been logged into the online service, the features of the online service that the user is currently interacting with, or the like.

The status generator 232 may be configured to determine one or more user status indicators based on the context information. Means for determining one or more user status indicators may include the processor 205, the status generator 232, algorithms for determining one or more user status indicators described herein and/or the like. In this regard, the context information may be used to determine user status indicators associated with various status indicator types. In some embodiments, mobile terminal context information and service context information (collectively referred to as context information) may be used to determine user status indicators associated various status indicator types. Example status indicator types may include a battery charge indicator type, an alarm indicator type, a media capturing indicator type, a network connectivity indicator type, a weather indicator type, a call indicator type, a movement indicator type, a current location indicator type, a media play indicator type, or the like.

In this regard, the status generator 232 may associate various classifications of context information to one or more status indicator types. The context information associated with a particular status indicator type may be analyzed and/or combined to determine a user status indicator associated with the status indicator type. In some embodiments, the status generator 232 may also be configured to retrieve additional information based on the mobile terminal context information and/or the service context information. The additional information may also be analyzed and/or combined to determine a user status indicator.

For example, mobile terminal context information that includes location information may be associated with a weather status indicator type. The location information may be analyzed by the status generator 232 to determine a user status indicator for each status indicator type. With respect to an example weather status indicator type, the status indicator generator 232 may use the location information to retrieve information (from the memory device 210 or via the network 225) regarding the weather at the location described by the location information. The retrieved weather information may be used to determine a user status indicator directed to a weather status indicator type. In this regard, the user status indicator can provide an indication of the weather where the user is currently located.

In another example, mobile terminal context information may be combined with service context information to determine a user status indicator associated with a media capturing indicator type. In this regard, mobile terminal context information including location information and media capturing information may be combined with service context information including the platform being used to access an online service and information regarding uploading a photo, to determine a user status indicator. In this example scenario, a user may capture a photo with a mobile terminal and the location information describing where the photo was taken, as well as the action of taking the photo, may be captured as mobile terminal context information. In this example scenario, the user then logs onto an online service via the mobile terminal and uploads the photo. Using the mobile terminal to login and upload the photo may be captured as service context information. The context information receiver 230 may receive the location information, the media capturing information, the platform information and the uploading information as context information, and the status generator 232 may analyze and combine the context information to determine a user status indicator. The determined user status indicator may be associated with a media capturing indicator type and may indicate that the user uploaded, from a mobile terminal, a picture taken at the described location.

The presenter 234 may be configured to provide for presentation of the user status indicators. Means for providing for presentation of the user status indicators may include the processor 205, the status generator 232, algorithms for providing for presentation of the user status indicators described herein and/or the like. The presenter 234 may provide for presentation of the user status indicators to the user interface 215, or via the network 225, to the server 240, the mobile terminal 245, the computer 250, or the like. In this regard, the user status indicators may be presented in an object that may be a frame, a window, a widget, an area of a webpage, or other medium that can be used to present user status indicators. Presenter 234 may also associate the user status indicators with a user account to provide for presentation of the user status indicators with an indication of the user account or in association with other content directed to the user account.

The user status indicators may be presented in a textual manner, a graphical manner, an audible manner, or the like. In some embodiments, a textual list of user status indicators may be provided in association with appropriate status indicator types. Further, in some embodiments, a graphical representation of the user status indicators may be provided (e.g., a location user status indicator may be presented on a map).

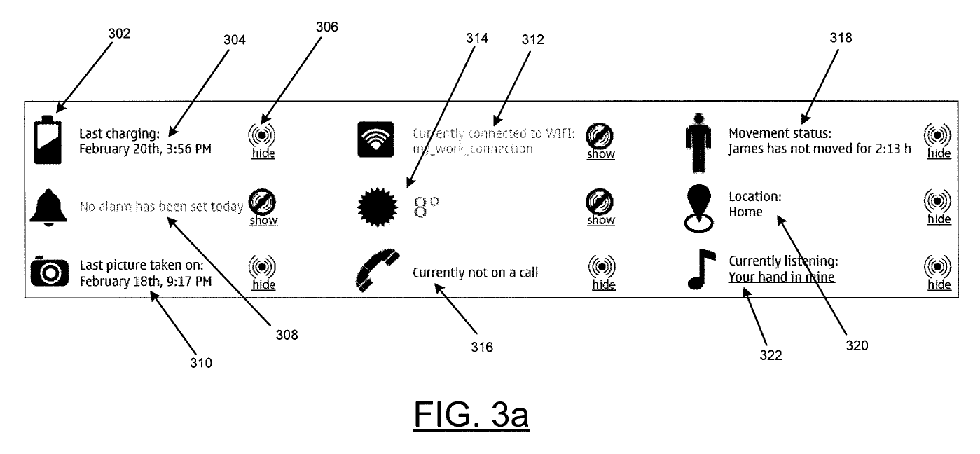

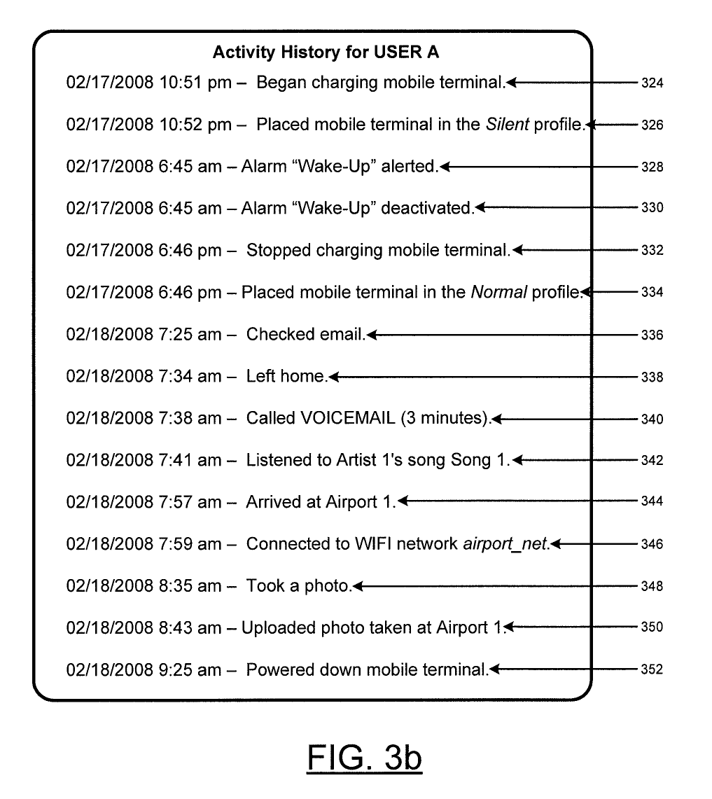

FIG. 3a depicts an exemplary presentation of user status indicators that combine both textual and graphical representations of user status indicators. The user status indicators depicted in FIG. 3a may be associated with a user account and the user status indicators may be updated as new context information is received by the context information receiver 230. In this regard, the exemplary presentation of FIG. 3 a may be associated with a user account and context information received from an associated mobile terminal.

The exemplary presentation of user status indicators of FIG. 3a includes nine user status indicators. However, embodiments of the present invention may include more, less, or different user status indicators. The user status indicator types of FIG. 3a include a battery charge user status indicator 300, an alarm user status indicator 308, a media capturing user status indicator 310, a network connectivity user status indicator 312, a weather user status indicator 314, a call user status indicator 316, a movement user status indicator 318, a current location user status indicator 320, and a media play user status indicator 322.

Each exemplary representation of a user status indicator also includes a graphic, a textual description, and a control. The graphical indicator may be dynamic (i.e., provide information about the user status indicator) or static. The textual description may provide information included in the user status indicator and the textual description may also be dynamic and be updated each time the user status indicator is updated. The control may be used to perform various actions with respect to the user status indicator including, for example, showing or hiding the user status indicator.

The battery charge user status indicator 300 of FIG. 3a includes a graphic 302, a textual description 304, and a control 306. To determine the battery charge user status indicator 300, mobile terminal context information may be received including information regarding the battery level, whether the mobile terminal is currently being charged, or the like. This context information may be analyzed to determine the battery charge user status indicator 300. As a result, the battery charge user status indicator 300 may provide information regarding the current battery level of the associated mobile terminal and the last time the mobile terminal was charged.

The exemplary presentation of FIG. 3a also includes an alarm user status indicator 308. To determine the alarm user status indicator 308, mobile terminal context information may be received including information regarding the time of an alarm (e.g., a calendar event) set on the mobile terminal. This context information may be analyzed to determine the alarm user status indicator 308. As a result, the alarm user status indicator 308 may provide information regarding when the alarm will alert or how long until the alarm will alert.

The exemplary presentation of FIG. 3a includes a media capturing user status indicator 310. To determine the media capturing user status indicator, mobile terminal context information may be received including information regarding when a camera module (e.g., camera module 37 of mobile terminal 10) was activated and whether a photo or video was captured. This context information may be analyzed to determine the media capturing user status indicator 310. As a result, the media capturing user status indicator 310 may provide information regarding the time when the last photo or video was captured by the mobile terminal.

FIG. 3a also includes a network connectivity user status indicator 312. To determine the network connectivity user status indicator 312, mobile terminal context information may be received including information regarding the networks and types of networks currently available for use by the mobile terminal. This context information may be analyzed to determine the network connectivity user status indicator 312. As a result, the network connectivity user status indicator 312 may provide information regarding network connections currently available to the mobile terminal.

FIG. 3a also includes a weather user status indicator 314. To determine the weather user status indicator 314, mobile terminal context information may be received including information regarding the location of the mobile terminal. This context information may be analyzed to determine the weather user status indicator 314. The location information may be used in association with retrieved weather information to determine the weather user status indicator 314. As a result, the weather user status indicator 314 may provide information regarding weather in the area of the mobile terminal.

FIG. 3a includes a call user status indicator 316. To determine the call user status indicator 316, mobile terminal context information may be received including information regarding current calls or other communications being handled by the mobile terminal and the parties to the call or other communication. This context information may be analyzed to determine the call user status indicator 316. As a result, the call status indicator 316 may provide information regarding whether the associated mobile terminal is currently handling a call or communication and who is initiating and receiving the call or communication.

FIG. 3a includes a movement user status indicator 318. To determine the movement user status indicator 318, mobile terminal context information may be received including information regarding the location information of the associated mobile terminal. This context information may be analyzed to determine the movement user status indicator 318. As a result, the movement user status indicator 318 may provide information regarding how long the mobile terminal has been located at the current location.

FIG. 3a also includes a location user status indicator 320. To determine the location user status indicator 320, mobile terminal context information may be received including information regarding the location of the mobile terminal. This context information may be analyzed to determine the location user status indicator 320. The location information may be used in association with retrieved information indicating what buildings, parks, or other geographic entities are located at the described location to determine the location user status indicator 320. As a result, the location user status indicator 320 may provide information regarding the location of the mobile terminal.

FIG. 3a also includes a media play user status indicator 322. To determine the media play user status indicator 322, mobile terminal context information may be received including information regarding the media content including the artist and song title that the mobile terminal is currently playing. This context information may be analyzed to determine the media play user status indicator 322. As a result, the media play user status indicator 322 may provide information regarding the media content currently being played by the mobile terminal including the title of the media and the artist.

Referring again to FIG. 2, in some embodiments, the status generator 232 may also be configured to determine user activities based on changes in the one or more user status indicators. In this regard, in some embodiments, the status generator 232 may be configured to determine user activities based on current and past changes in the one or more user status indicators. Moreover, when new context information is received that changes a user status indicator, the change in the user status indicator may determine a user activity. For example, if a location user status indicator specifies that a mobile terminal is “at home,” and new mobile terminal context information results in the location user status indicator changing to “at work,” a user activity can be defined indicating that the user of the mobile terminal has traveled to work. In this regard, the past user status indicator (i.e., user is at home) can also be used to define a user activity, where the user activity indicates that the user traveled from home to work.

In some embodiments, changes to select user status indicators may provide for determining a user activity. In other words, not all changes in user status indicators may result in determining a user activity. For example, if the weather changes at a location associated with a mobile terminal, a weather user status indicator may change, but a user activity may not be determined. Further, in some embodiments, whether a change in a user status indicator results in determining a user activity may be configurable by a user.

In some embodiments, the presenter 234 may also be configured to provide for the presentation of user activities. The presenter 234 may also be configured to provide for the presentation of user activities in association with a user account of an online service. The presenter 234 may provide for the presentation of the user activities to the user interface 215, or via the network 225, to the server 240, the mobile terminal 245, the computer 250, or the like. In this regard, the user activities may be presented in an object that may be a frame, a window, a widget, an area of a webpage, or other medium that can be used to present user status indicators. Further, historical representations of a number of user activities may also be presented. The presenter 234 may provide for presentation of user activities in a textual manner, a graphical manner, an audible manner, or the like. For example, with respect to location user status indicators being presented in a graphical manner, a map may be provided that depicts a user activity showing a user moving from a first location (e.g., home) to a second location (e.g., work).

Further, in some embodiments, status generator 232 and presenter 234 may combine user activities to generate a combination user activity. For example, one user activity may indicate that a user is located at the airport in London. A second user activity may indicate that the user is in Helsinki at a later time. These two user activities may be combined into a single user activity indicating that the user has flown from London to Helsinki. In another example, user activities may be combined with respect to media playback. In this regard, two separate user activities indicating that a user is playing songs on the same album, may result in a combine user activity indicating that the user is playing an album. In some embodiments, user activities may be combined based on the dates associated with the user activities. For example, in some embodiments, user activities may be associated with data stamps of when the user activity occurred. In this regard, user activities may be combined when the user activities are older than a particular threshold (e.g., one week, one month, etc.).

FIG. 3b depicts an exemplary presentation of user activities in an exemplary textual list of historical user activities. The user activities depicted in FIG. 3a may be associated with a user account (i.e., the user account associated with USER A). Each user activity in the textual list of FIG. 3b is indicative of a change in one or more underlying user status indicators. Each user activity may also be associated with a time stamp. The time stamp associated with the user activity may be captured when one or more underlying user status indicators changes. Further, in various embodiments, user activities may be filtered and/or combined. In this regard, some changes in user status indicators may not have an associated user activity, and in some instances more one than change in a user status indicator may be associated with a single user activity.

The exemplary presentation of user activities of FIG. 3b includes a charging user activity at 324. The charging user activity indicates that the user of the mobile terminal began charging the mobile terminal. The charging user activity at 324 may be determined based on a change in a battery charge user status indicator. At 332, a similar charging user activity is provided indicating that the user discontinued charging of the mobile terminal.

At 326, a profile user activity is provided indicating that the user placed the mobile terminal in a “silent” profile. The profile user activity may be determined based on a change in a profile user status indicator. At 334, a similar profile user activity is provided indicating that the user placed the mobile terminal in a “normal” profile.

At 328, an alarm user activity is provided indicating that an alarm of the mobile terminal alerted. The alarm user activity at 328 may be determined based on a change in an alarm user status indicator. At 330, another alarm user activity is provided indicating that the alarm of the mobile terminal was deactivated. Again, the alarm user activity at 330 may be determined based on a change in an alarm user status indicator. In this regard, the alarm user status indicator may have changed from “alerting” to “deactivated.”

At 336, an email user activity is provided indicating that the user checked her email on the mobile terminal. The email user activity at 336 may be determined based on a change in an email user status indicator that specifies the last time the user checked email.

At 338, a location user activity is provided indicating that the user left her home. The location user activity at 338 may be determined based on a change in a location user status indicator. At 334, a similar location user activity is provided indicating that the user arrived at the airport.

At 340, a call user activity is provided indicating that the user called a contact (i.e., “voicemail”) on the mobile terminal. The call user activity at 336 may be determined based on a change in a call user status indicator that specifies whether the mobile terminal is handling a call. Additionally, based on past call user status indicators the duration of the call (i.e., 3 minutes) may be provided in the user activity.

At 342, a media play user activity is provided indicating that the user played Song 1 on the mobile terminal. The media play user activity at 342 may be determined based on a change in a media play user status indicator that specifies whether the mobile terminal is playing media and the title of the media.

At 346, a network connectivity user activity is provided indicating that the mobile terminal connected to a new network. The network connectivity user activity at 346 may be determined based on a change in a network connectivity user status indicator that specifies the network connections available to the mobile terminal.

At 348, a media capture user activity is provided indicating that the mobile terminal captured a photo. The media capture user activity at 348 may be determined based on a change in a media capture user status indicator that specifies that a photo or other media item has been captured by the mobile terminal.

At 350, a photo upload user activity is provided indicating that the mobile terminal uploaded a captured photo. The photo upload user activity at 350 may be determined based on a change in a media capture user status indicator and a change in a upload user status indicator. In this regard, changes in both user status indicators may be used to determine the photo upload user activity.

At 352, a power down user activity is provided indicating that the mobile terminal was powered down. The power down user activity at 352 may be determined based on a change in a power user status indicator that specifies whether the mobile terminal is in a powered up or powered down state.

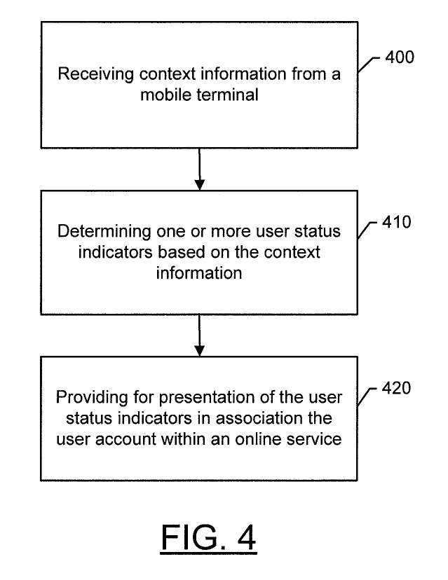

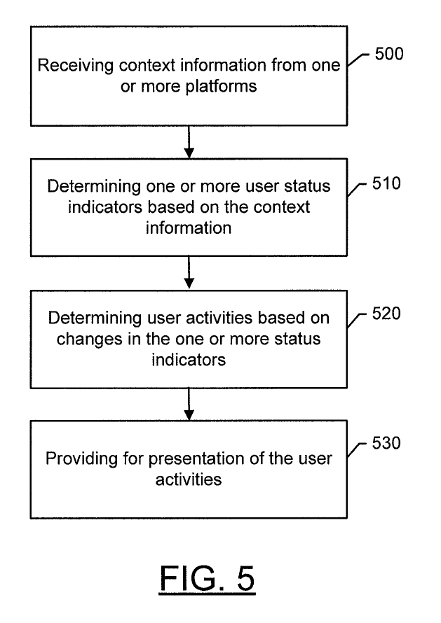

FIGS. 4 and 5 are flowcharts of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions, or executable program code portions. For example, one or more of the procedures described above may be embodied by computer program instructions. In this regard, the computer program instructions which embody the procedures described above may be stored by a memory device of the apparatus and executed by a processor in the apparatus. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one exemplary embodiment of a method for determining user status indicators as provided in FIG. 4 may include receiving context information from one or more platforms at 400. In some embodiments, one of the platforms may be a mobile terminal. The mobile terminal may be associated with an account of an online service. In some embodiments, the context information includes mobile terminal information and/or service context information. In this regard, the mobile terminal may be associated with a user account of an online service. Further, the context information may include information regarding the platform a user is currently using to access the online service. The received context information may include location information and/or information regarding operations currently being performed by a mobile terminal.

The exemplary method may also include determining one or more user status indicators based on the context information at 410. In some embodiments, the one or more status indicators may be determined based on mobile terminal context information and/or service context information. The exemplary method may also include providing for presentation of the user status indicators in association with the user account at 420.

In an exemplary embodiment, the method may also include additional optional operations. In such embodiments, the method may include retrieving additional information. The additional information may be retrieved based on received mobile terminal context information. Further, where additional information is retrieved, determining one or more user status indicators may be based on the additional information.

Another exemplary embodiment of a method for determining user status indicators as provided in FIG. 5 may include receiving context information from one or more platforms at 500. In some embodiments, one of the platforms may be a mobile terminal. The mobile terminal may be associated with an account of an online service. In some embodiments, the context information includes mobile terminal information and/or service context information. In this regard, the mobile terminal may be associated with a user account of an online service. Further, the service context information may include information regarding the platform a user is currently using to access the online service. The received context information may include location information and/or information regarding operations currently being performed by a mobile terminal.

The exemplary method may also include determining one or more user status indicators based on the context information at 510. In some embodiments, the one or more status indicators may be determined based on mobile terminal context information and/or service context information. The exemplary method may also include determining user activities based on changes in the one or more user status indicators at 520. In some embodiments, determining user activities may also include determining user activities based on current and past user status indicators. Further, the exemplary method may include providing for presentation of the user activities in association with the user account at 530.

In an additional exemplary embodiment, the method may also include additional optional operations. In such embodiments, the method may include retrieving additional information based on the mobile terminal context information. The additional information may be retrieved based on received context information. Further, where additional information is retrieved, determining one or more user status indicators may be based on the additional information.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving context information from one or more platforms;
determining one or more user status indicators based on the context information; and
providing for presentation of the user status indicators in association with the user account.

2. The method of claim 1 further comprising:
determining user activities based on changes in the one or more user status indicators; and
providing for presentation of the user activities in association with the user account.

3. The method of claim 2, wherein determining user activities includes determining user activities based on current and past user status indicators.

4. The method of claim 1, wherein receiving context information includes receiving context information from one or more platforms, the context information including mobile terminal context information, the one or more platforms including a mobile terminal, and the mobile terminal being associated with a user account of an online service.

5. The method of claim 4, wherein receiving context information includes receiving context information, the context information including service context information.

6. The method of claim 5, wherein receiving context information includes receiving context information, the context information including information regarding the platform a user is currently using to access the online service.

7. The method of claim 1 further comprising:
retrieving additional information based on the context information; and
wherein determining one or more user status indicators includes determining one or more user status indicators based on the additional information.

8. The method of claim 1, wherein receiving context information includes receiving context information, the context information including mobile terminal location information.

9. The method of claim 1, wherein receiving context information includes receiving context information, the context information including operations currently being performed by the mobile terminal.

10. A computer program product comprising at least one computer-readable storage medium having computer-readable program code portions stored therein, the computer-readable program code portions comprising:
a first program code portion configured to receive context information from one or more platforms;
a second program code portion configured to determine one or more user status indicators based on the context information; and
a third program code portion configured to provide for presentation of the user status indicators in association with the user account.

11. The computer program product of claim 10, wherein the computer-readable program code portions further comprise:
a fourth program code portion configured to determine user activities based on changes in the one or more user status indicators; and
a fifth program code portion configured to provide for presentation of the user activities in association with the user account.

12. The computer program product of claim 11, wherein the fourth program code portion configured to determine user activities includes being configured to determine user activities based on current and past user status indicators.

13. The computer program product of claim 10, wherein the first program portion configured to receive context information includes being configured to receive context information from one or more platforms, the context information including mobile terminal context information, the one or more platforms including a mobile terminal, and the mobile terminal being associated with a user account of an online service.

14. The computer program product of claim 13, wherein the first program code portion being configured to receive context information includes being configured to receive context information including service context information.

15. The computer program product of claim 14, wherein the first program code portion being configured to receive context information includes being configured to receive context information, the context information including information regarding the platform a user is currently using to access the online service.

16. The computer program product of claim 10, wherein the computer-readable program code portions further comprise:
a fourth program code portion configured to retrieve additional information based on the context information; and
wherein the second program code portion configured to determine one or more user status indicators includes being configured to determine one or more user status indicators based on the additional information.

17. The computer program product of claim 10, wherein the first program code portion configured to receive context information includes being configured to receive context information, the context information including mobile terminal location information.

18. The computer program product of claim 10, wherein the first program code portion configured to receive context information includes being configured to receive context information, the context information including operations currently being performed by the mobile terminal.

19. An apparatus comprising a processor, the processor configured to:
receive context information from one or more platforms;
determine one or more user status indicators based on the context information; and
provide for presentation of the user status indicators in association with the user account.

20. The apparatus of claim 19, wherein the processor further configured to:
determine user activities based on changes in the one or more user status indicators; and
provide for presentation of the user activities in association with the user account.

21. The apparatus of claim 20, wherein the processor being configured to determine user activities, includes being configured to determine user activities based on current and past user status indicators.

22. The apparatus of claim 19, wherein the processor configured to receive context information includes being configured to receive context information from one or more platforms, the context information including mobile terminal context information, the one or more platforms including a mobile terminal, and the mobile terminal being associated with a user account of an online service.

23. The apparatus of claim 22, the processor configured to receive context information includes being configured to receive context information including service context information.

24. The apparatus of claim 23, wherein the processor being configured to receive context information includes being configured to receive context information, the context information including information regarding the platform a user is currently using to access the online service.

25. The apparatus of claim 19, wherein the processor is further configured to:
retrieve additional information based on the context information; and
wherein the processor being configured to determine one or more user status indicators includes being configured to determine one or more user status indicators based on the additional information.

26. The apparatus of claim 19, wherein the processor being configured to receive context information includes being configured to receive context information, the context information including mobile terminal location information.

27. The apparatus of claim 19, wherein the processor being configured to receive context information includes being configured to receive context information, the context information including operations currently being performed by the mobile terminal.

28. The apparatus of claim 19 further comprising a memory device, and wherein the processor is configured to store user status indicators on the memory device.

29. An apparatus comprising:
means for receiving context information from one or more platforms;
means for determining one or more user status indicators based on the context information; and
means for providing for presentation of the user status indicators in association with the user account within an online service.

30. The apparatus of claim 29 further comprising:
means for determining user activities based on changes in the one or more user status indicators; and
means for providing for presentation of the user activities in association with the user account.
